(19) United States
(12) Patent Application Publication
(10) Pub. No.: US 2006/0005671 A1
(43) Pub. Date: Jan. 12, 2006

(54) Screwdriver having larger driving force

(76) Inventor: Chih-Ching Hsieh, Taichung (TW)

Correspondence Address: Chih-Ching Hsieh, Box 8-24, 235 Chung-Ho, Taipei, TW

(21) Appl. No.: 11/223,692

(22) Filed: Sep. 12, 2005

Related U.S. Application Data
(63) Continuation-in-part of application No. 10/638,931, filed on Aug. 8, 2003.

(51) Int. Cl. B25B 15/00; B25B 23/00

(52) U.S. Cl. 81/436

(57) ABSTRACT

A screwdriver comprises a tip having a substantially I-shaped cross-section and comprising a first end formed with a first resting portion, a second end formed with a second resting portion, and a mediate section formed with an auxiliary resting portion located between the first resting portion and the second resting portion. A width between two larger sides of the auxiliary resting portion is 0.3 to 0.5 times of that of the first resting portion and that of the second resting portion. A length between two shorter sides of the auxiliary resting portion is 0.3 to 0.5 times of a length connected two shorter sides of the tip. The first resting portion and the second resting portion of the tip are bent and deformed when being subjected to a torque.

The present invention is a continuation in part (CIP) of the U.S. Patent Application with Series Number of 10/638931 assigned and invented by the inventor and applicant of the present invention. Thus, the content of U.S. patent application with Ser. No. of 10/638,931 is incorporated into the present invention as a part of the present invention.

### BACKGROUND OF THE INVENTION

1. Field of the Invention

The present invention relates to a screwdriver, and more particularly to a screwdriver having a larger driving force and torque.

2. Description of the Related Art

A conventional screwdriver 40 in accordance with the prior art shown in FIGS. 5 and 6 comprises a flat tip 42 inserted into the groove 52 of a screw 50. When the screwdriver 40 is rotated relative to the screw 50, only two points 44 and 46 of the tip 42 of the screwdriver 40 are in contact with the wall of the groove 52 of the screw 50, thereby decreasing the driving force of the screwdriver 40 applied on the screw 50. In addition, only two points 44 and 46 of the tip 42 of the screwdriver 40 are in contact with the wall of the groove 52 of the screw 50, so that the wall of the groove 52 of the screw 50 is easily Worn out due to a stress concentration.

### SUMMARY OF THE INVENTION

The primary objective of the present invention is to provide a screwdriver having a larger driving force and torque.

Another objective of the present invention is to provide a screwdriver, wherein by provision of the auxiliary resting portion of the tip, the first resting portion and the second resting portion are slightly bent and deformed and are entirely flush with the wall of the groove of the screw to increase the contact area between the tip and the wall of the groove of the screw, so that the tip of the screwdriver can apply a larger driving force to drive the screw, thereby facilitating the user rotating the screw.

A further objective of the present invention is to provide a screwdriver, wherein the first resting portion and the second resting portion are entirely flush with the wall of the groove of the screw respectively, so that the contact area between the tip of the screwdriver and the wall of the groove of the screw is largely increased, thereby preventing the tip of the screwdriver from being worn out due to a stress concentration.

A further objective of the present invention is to provide a screwdriver, wherein the tip of the screwdriver is closely combined with the wall of the groove of the screw rigidly and stably, thereby preventing the wall of the groove of the screw from being worn out due to an excessive force.

In accordance with the present invention, there is provided A screwdriver comprises a tip having a substantially I-shaped cross-section comprising: a first end formed with a first resting portion, a second end formed with a second resting portion, and a mediate section formed with an auxiliary resting portion located between the first resting portion and the second resting portion; A width between two larger sides of the auxiliary resting portion is 0.3 to 0.5 times of that of the first resting portion and that of the second resting portion. A length between two shorter sides of the auxiliary resting portion is 0.3 to 0.5 times of a length connected two shorter sides of the tip. The first resting portion and the second resting portion of the tip are bent and deformed when being subjected to a torque.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a screwdriver in accordance with the preferred embodiment of the present invention;

FIG. 2 is a partially enlarged view of the screwdriver as shown in FIG. 1;

FIG. 3 is a side plan cross-sectional assembly view of the screwdriver and a screw;

FIG. 4 is a schematic operational view of the screwdriver and the screw as shown in FIG. 3;

FIG. 5 is a side plan cross-sectional assembly view of a conventional screwdriver and a screw in accordance with the prior art; and

FIG. 6 is a schematic operational view of the conventional screwdriver and the screw as shown in FIG. 5.

### DETAILED DESCRIPTION OF THE INVENTION

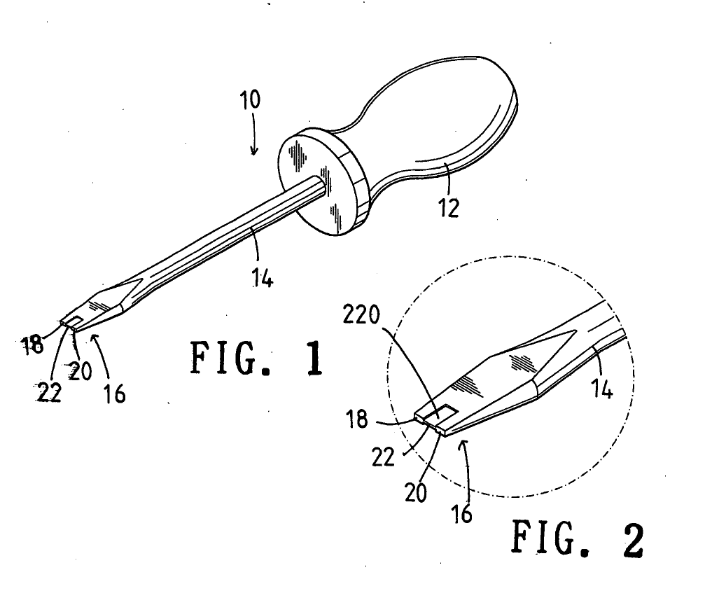

Referring to the drawings and initially to FIGS. 1-3, a screwdriver 10 in accordance with the preferred embodiment of the present invention comprises a shank 14, a handle 12 mounted on a first end of the shank 14, and a flat tip 16 mounted on a second end of the shank 14.

The tip 16 has a substantially I-shaped cross-section and has a first end formed with a first resting portion 18, a second end formed with a second resting portion 20, and a mediate section formed with an auxiliary resting portion 22 located between the first resting portion 18 and the second resting portion 20.

Preferably, each of the first resting portion 18 and the second resting portion 20 has a substantially rectangular cross-section.

Preferably, the auxiliary resting portion 22 of the tip 16 is integrally connected between the first resting portion 18 and the second resting portion 20. Preferably, the auxiliary resting portion 22 of the tip 16 has a thickness smaller than that of each of the first resting portion 18 and the second resting portion 20, so that the auxiliary resting portion 22 of the tip 16 can be deformed when the first resting portion 18 and the second resting portion 20 are subjected to a rotational torque. Preferably, the auxiliary resting portion 22 of the tip 16 has a top and a bottom each formed with a depression 220 to enhance flexibility of the auxiliary resting portion 22 of the tip 16, thereby facilitating deformation of the auxiliary resting portion 22 of the tip 16.

Furthermore, at an end of the tip of the screwdriver, all the sides of the first and second resting portions 18, 20 and the auxiliary resting portion 22 are straight and all the corners formed by the connections of the first resting portion 18, the auxiliary resting portion 22 and the second resting portion 20 are approximate right angles; and an end surface of the first resting portion 18, an end surface of the auxiliary resting portion 22, and an end surface of the second resting portion 20 are at the same plane.

Referring to FIG. 2, a width between two larger sides of the auxiliary resting portion 22 is 0.3 to 0.5 times of that of the first resting portion 18 and that of the second resting portion 20. A length between two shorter sides of the auxiliary resting portion 22 is 0.3 to 0.5 times of a length connected two shorter sides of the tip 16.

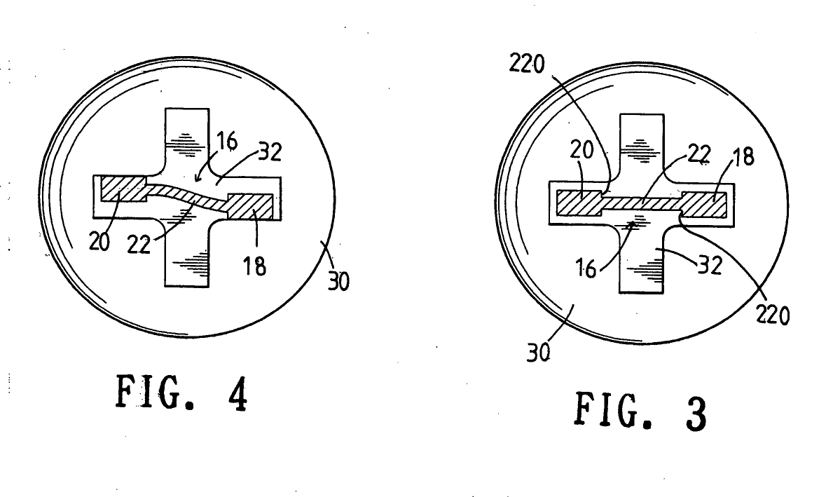

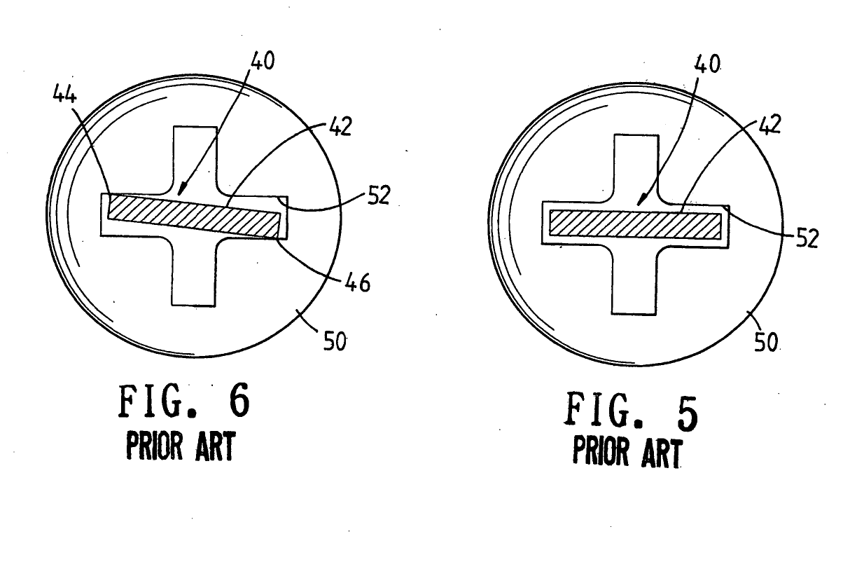

In operation, referring to FIGS. 3 and 4 with reference to FIGS. 1 and 2, the tip 16 is inserted into the groove 32 of a screw 30 as shown in FIG. 3. When the screwdriver 10 is rotated relative to the screw 30, the tip 16 is rotated and moved from the position as shown in FIG. 3 to the position as shown in FIG. 4, so that the first resting portion 18 and the second resting portion 20 are subjected to a torque exerted by the wall of the groove 32 of the screw 30. At this time, the auxiliary resting portion 22 of the tip 16 is slightly deformed when the first resting portion 18 and the second resting portion 20 are subjected to the torque, so that the first resting portion 18 and the second resting portion 20 are slightly bent and deformed and are entirely flush with the wall of the groove 32 of the screw 30 respectively, thereby greatly increasing the contact area between the first resting portion 18 and the second resting portion 20 and the wall of the groove 32 of the screw 30.

Thus, the tip 16 of the screwdriver 10 is combined with the wall of the groove 32 of the screw 30 rigidly and stably, so that the tip 16 of the screwdriver 10 can apply a larger driving force to drive the screw 30.

Accordingly, by provision of the auxiliary resting portion 22 of the tip 16, the first resting portion 18 and the second resting portion 20 are slightly bent and deformed and are entirely flush with the wall of the groove 32 of the screw 30 respectively to increase the contact area between the tip 16 and the wall of the groove 32 of the screw 30, so that the tip 16 of the screwdriver 10 can apply a larger driving force to drive the screw 30, thereby facilitating the user rotating the screw 30.

In addition, the first resting portion 18 and the second resting portion 20 are entirely flush with the wall of the groove 32 of the screw 30 respectively, so that the contact area between the tip 16 of the screwdriver 10 and the wall of the groove 32 of the screw 30 is largely increased, thereby preventing the tip 16 of the screwdriver 10 from being worn out due to a stress concentration.

Further, the tip 16 of the screwdriver 10 is closely combined with the wall of the groove 32 of the screw 30 rigidly and stably, thereby preventing the wall of the groove 32 of the screw 30 from being worn out due to an excessive force.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A screwdriver having a tip; the tip having a substantial I-shaped cross-section and comprising: a first end formed with a first resting portion, a second end formed with a second resting portion, and a mediate section formed with an auxiliary resting portion located between the first resting portion and the second resting portion;
wherein a width between two larger sides of the auxiliary resting portion is 0.3 to 0.5 times of that of the first resting portion or that of the second resting portion; a length between two shorter sides of the auxiliary resting portion is 0.3 to 0.5 times of a length connected two shorter sides of the I shaped tip; and
wherein the first resting portion and the second resting portion of the tip are bent and deformed when being subjected to a torque.

2. The screwdriver in accordance with claim 1, wherein the first resting portion of the tip has a substantially rectangular cross-section.

3. The screwdriver in accordance with claim 1, wherein the second resting portion of the tip has a substantially rectangular cross-section.

4. The screwdriver in accordance with claim 1, wherein the auxiliary resting portion of the tip is integrally connected between the first resting portion and the second resting portion.

5. The screwdriver in accordance with claim 1, wherein the auxiliary resting portion of the tip has a top formed with a depression.

6. The screwdriver in accordance with claim 1, wherein the auxiliary resting portion of the tip has a bottom formed with a depression.

7. The screwdriver in accordance with claim 1, wherein at an end of the tip of the screwdriver, all the sides of the first and second resting portions and the auxiliary resting portion are straight and all the corners formed at the connections of the first resting portion, the auxiliary resting portion and the second resting portion are approximate right angles; and an end surface of the first resting portion, an end surface of the auxiliary resting portion, and an end surface of the second resting portion are at the same plane.

8. The screwdriver in accordance with claim 1, wherein the first resting portion of the tip has a substantially rectangular cross-section; the second resting portion of the tip has a substantially rectangular cross-section; the auxiliary resting portion of the tip is integrally connected between the first resting portion and the second resting portion; the auxiliary resting portion of the tip has a top formed with a depression; the auxiliary resting portion of the tip has a bottom formed with a depression; at an end of the tip of the screwdriver, all the sides of the first and second resting portions and the auxiliary resting portion are straight and all the corners formed by the connections of the first resting portion, the auxiliary resting portion and the second resting portion are approximate right angles; and an end surface of the first resting portion, an end surface of the auxiliary resting portion, and an end surface of the second resting portion are at the same plane.
